(19) United States
(12) Patent Application Publication
(10) Pub. No.: US 2011/0080521 A1
(43) Pub. Date: Apr. 7, 2011

(54) ON-SCREEN DISPLAY TO HIGHLIGHT WHAT A DEMO VIDEO IS MEANT TO ILLUSTRATE

(75) Inventors: ROBERT HARDACKER, Escondido, CA (US); Robert Allan Unger, El Cajon, CA (US); Christopher Jensen Read, San Diego, CA (US)

(73) Assignees: SONY CORPORATION; SONY ELECTRONICS INC.

(21) Appl. No.: 12/573,629

(22) Filed: Oct. 5, 2009

(51) Int. Cl. H04N 5/50

(52) U.S. Cl. 348/569; 348/E05.097; 386/E05.003

(57) ABSTRACT

Metadata defining an on-screen display (OSD) including text and/or symbols is embedded in a demonstration video for play on a TV in a retail outlet. The metadata is executed by the TV to overlay the OSD on the demonstration video to identify various advantages provided by the TV.

### I. FIELD OF THE INVENTION

The present application relates generally to providing an on-screen TV display overlaid on a demonstration video to better highlight the features that the demo video is intended to illustrate.

### II. BACKGROUND OF THE INVENTION

The sale of TVs is extremely competitive. As understood herein the primary opportunity for extolling desirable TV features is on the showroom floor to differentiate, demonstrate, and illustrate the differences between a particular TV brand being sold and other brand TVs.

As further understood herein, these differences are becoming more subtle and difficult to understand for untrained consumers. Sales people can be trained to show and explain demonstration videos on TVs but the training can be uneven and the demonstration videos don't necessarily reflect the actual performance of the TV or otherwise unambiguously highlight the features expected to be the most attractive.

Furthermore, present principles understand that a TV manufacturer might desire that any demonstration videos it provides for its own TVs not be used to demonstrate TV models used by other manufacturers, as otherwise might occur were closed captioning to be inserted into a demonstration video by way of explaining particular features intended to be illustrated by the video.

### SUMMARY OF THE INVENTION

An on-screen display (OSD) is defined in metadata embedded in a demonstration video for a TV. The TV reads, filters, and acts upon the metadata to generate the OSD and overlay it on the underlying video. The OSD may include, e.g., simple text or graphics to draw the viewer's attention to a particular detail of the demo material. Generation of and display of the OSD occurs automatically when the video is played back through the TV, such that the OSD is not present in the normally viewed video absent the metadata and TV processor that knows how to use it.

Accordingly, a system includes a TV display and a TV processor controlling the display and accessing a tangible computer readable storage medium bearing instructions to cause the processor to receive a demonstration video containing a video stream and metadata embedded in the stream. The processor is caused to present the video stream and to overlay on the video stream an on-screen display (OSD) containing text and/or symbols represented by the metadata at screen locations indicated by the metadata.

In examples, the demonstration video with metadata is provided on an optical disk engageable with a disk player communicating with the TV processor. The TV processor may be programmed to recognize and properly interpret the metadata, and TV processors lacking the programming to recognize the metadata can play the video stream but cannot present the OSD overlaid thereon.

In example embodiments the symbol can include a box and/or circle and the text can indicate an absence of a display anomaly such as a moiré pattern and/or mosquito noise. In effect, the metadata defines a script interpreted and executed by the TV processor to establish the OSD at a screen location and at a video temporal location defined by the script. If desired, the disk can bear plural scripts established by plural sets of metadata each associated with a respective refresh rate and/or native screen resolution, with the TV processor selecting the script corresponding to the refresh rate of the TV.

In another aspect, a computer readable storage medium stores at least one demonstration video and metadata embedded in the video and defining a script executable by a TV processor. The script causes the TV processor to overlay on the video an on-screen display (OSD) having text and/or symbols highlighting the benefit of at least one predetermined TV feature as exemplified in the video.

In another aspect, a method includes displaying a TV in a retail outlet, engaging a demonstration video disk with a video disk player communicating with the TV, and presenting on the TV a demonstration video on the disk. The method also includes accessing a metadata script on the disk and responsive to commands in the script, overlaying, on the demonstration video presented on the TV, an on-screen display (OSD) containing symbols and/or text called out in metadata on the disk.

The details of the present invention, both as to its structure and operation, can best be understood in reference to the accompanying drawings; in which like reference numerals refer to like parts, and in which:

### BRIEF DESCRIPTION OF THE DRAWINGS

FIG. 1 is a block diagram of an example system in accordance with present principles;

FIG. 2 is a flow chart of example set-up logic;

FIG. 3 is a flow chart of example operating logic; and

FIG. 4 is a screen shot of an example OSD overlaid on a demonstration video image.

### DETAILED DESCRIPTION OF THE PREFERRED EMBODIMENT

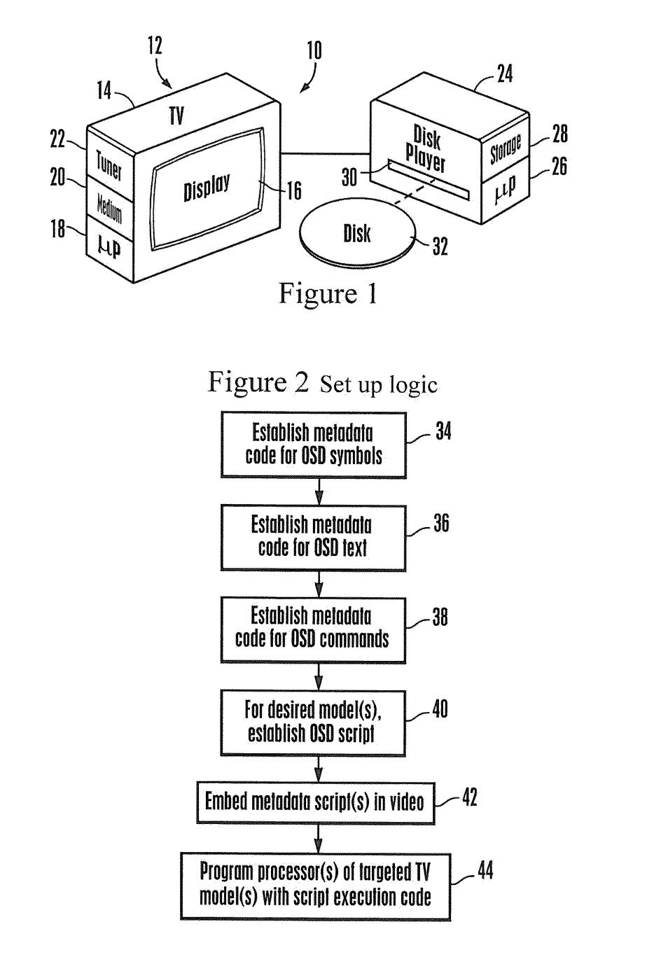

Referring initially to FIG. 1, a system 10 is shown that includes a TV 12 with TV chassis 14 bearing a TV display 16 such as but not limited to a flat panel matrix or plasma display. The display 16 is controlled by a TV processor 18 accessing a computer readable storage medium 20 to present video images from a selected video source such as a TV tuner 22 or disk player 24. The computer readable storage medium may be solid state or disk-based storage containing data and instructions to the TV processor 18 to execute portions of the logic divulged below. It is to be understood that while FIG. 1 shows that the processor 18, medium 20, and TV tuner 22 are in the chassis 14, in alternate embodiments one or more of these components may be separately housed in, e.g., a set-top box.

The disk player 24 typically contains a disk processor 26 accessing a computer readable storage medium 28. Also, the disk player 24 can include one or more receptacles 30 for receiving one or more optical video disks 32 therein, for processing of data on the disk 32 and sending resulting image information to the TV processor 18 for presentation on the TV display 16. The disk player 24 alternatively may be incorporated into the TV chassis 14.

FIG. 2 commences at block 34 in which metadata code is established corresponding to desired OSD symbols such as arrows, boxes, circles, etc. Also, at block 36 metadata code is established corresponding to desired text, e.g., letters and/or words. At block 38 metadata code is established for processor commands. For example, a processor command might be “display the symbol corresponding to the following metadata symbol code along with the text corresponding to the following metadata text code”.

Proceeding to block 40, for each TV model desired to play a demonstration video with an OSD overlay in accordance with present principles, an OSD script is established. The script is composed of metadata code for desired symbols, text, potentially in multiple languages, and commands. An example script might be metadata code representing a box and the textual phrase “note absence of moiré pattern during scan”, along with display position information indicating where on the display the commanded symbols and text are to be presented. Also, timing information can be included explicitly or implicitly in the script. For example, a script command might include an explicit command to present a particular symbol or text at a particular elapsed time into the video, or at a particular frame number in the video. Or, the metadata script may insert a display command at a particular location in the transport stream of the video for immediate presentation of the associated OSD as soon as the metadata is received, which is an example of an implied time command.

Envisioning that TV models may vary within a model group, multiple scripts may be established, one for each variance, and then embedded at block 42 within a single demonstration video on a demonstration video disk 32, with the TV processor selecting the appropriate script for its particular variation. For example, some TVs in a model line may have different refresh rates, e.g., 60 Hz or 120 Hz or 240 Hz refresh rates. In such an example three scripts may be provided, one for each refresh rate, such that a single demonstration video can display three different OSDs such as “60 Hz”, “120 Hz”, and “240 Hz”. This can be done by referencing certain feature variables preserved within the TV with code strings in the metadata that the TV replaces with its own specific value. A variation is to provide a high level script that the TV processor interprets so that, for instance, the high level script command “show refresh rate” causes the TV processor, depending on the actual refresh rate of its associated TV, to display a numerical refresh rate, typically in units of Hertz.

At block 44, the manufacturer programs with execution code the TV processors in the desired TV models to read the metadata discussed above and execute commands therein. Thus, in such an embodiment only TVs programmed to read the metadata can exploit the OSD feature described herein. Other TVs, e.g., TVs made by other manufacturers but not programmed to read the metadata in the video, can present the demonstration video but not the OSD that highlights advantageous features.

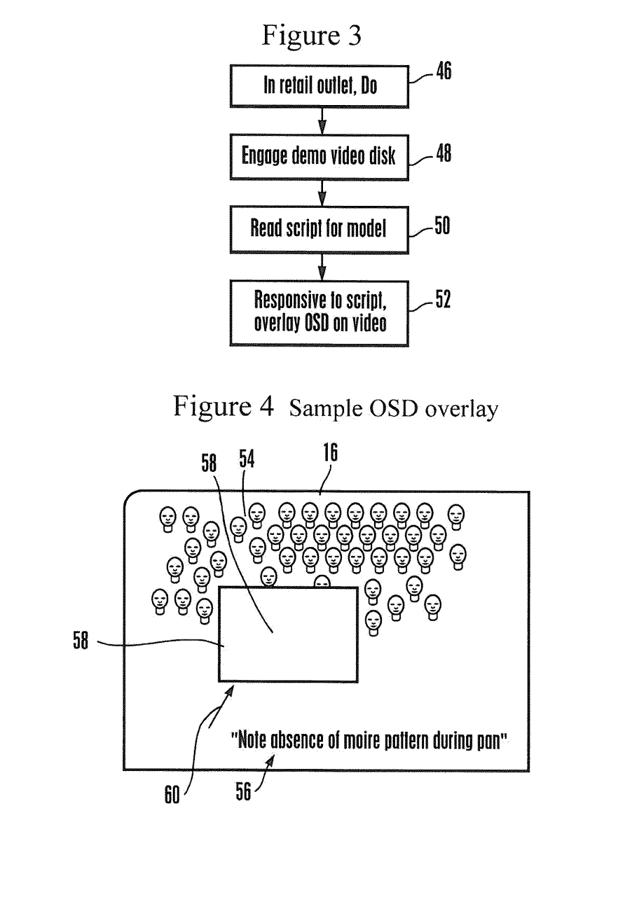

With the above in mind, at block 46 in FIG. 3 the TV 12 can be displayed in a retail outlet and a demonstration video disk 32 engaged with the video disk player 24 at block 48. As the disk plays, the TV 12 presents video on the disk. At block 50, the TV processor or disk processor also reads the metadata script on the disk, and when multiple metadata scripts are present on the disk the script pertaining to the particular variation associated with the TV processor 18 is read. Responsive to commands in the script, an on-screen display (OSD) containing the symbols and text called out in the metadata is overlaid onto the video.

FIG. 4 shows an example. Video 54 of, e.g., a pan shot of a crowd of people is presented from the disk 32 on the TV display 16. Also, responsive to a script command to present text as defined by metadata in the video, text 56 is overlaid on the image 54, in the example shown, to indicate “note absence of moiré pattern during pan”. A box symbol 58 as defined by metadata in the video may also be overlaid on the portion of the video lacking the moiré pattern and an arrow symbol 60 overlaid on the video to connect the message of the text 56 to the box 58. The text 56, box 58, and arrow 60 are overlaid on portions of the video identified in the metadata script, at times (equivalently, at video stream temporal locations) identified in the script.

It may now be appreciated that present principles allow a TV manufacturer to add text and/or simple graphics such as a circle or an arrow or a box to focus the consumer's view on a particular area. The example of FIG. 4 for instance can be used to demonstrate that a moiré pattern that might be displayed by other TVs during a pan shot across a crowd is not presented on the TV display 16 to, e.g., demonstrate the advantage of a high frame refresh rate. Greying down of items not of interest may also be additionally used to further highlight the areas of interest.

If desired, a user may be permitted to enter a value set to the TV that would select a specific set of metadata to interpret for that TV.

Furthermore, in some implementations the above-described OSD capability can have the ability to apply tutorial information to consumers by “pointing out” other specific digital anomalies with an arrow or circle while displaying the name of the anomaly (such as mosquito noise, macro block, etc.) that would look worse in other TVs compared to the TV being demonstrated. The OSD overlay capability can be further enhanced if desired when the metadata is being delivered via a transport stream by supporting images that can be presented as transparent overlays. Further, the metadata may be repeated throughout the video as appropriate for causing desired OSD information to be presented at desired times (temporal locations) in the video.

In some embodiments a second video can be embedded in the stream and overlaid on the primary video with a transparency factor that accomplished the same functions as OSD graphics and symbols to, e.g., support animation as an attention-getting mechanism.

The above features may be enabled from a setup screen. Or, normal content can omit the script and therefore enabling the above OSD features can be “on” in the TV at all times so that when content containing the OSD script is played, the OSD features are implemented.

While the particular ON-SCREEN DISPLAY TO HIGHLIGHT WHAT A DEMO VIDEO IS MEANT TO ILLUSTRATE is herein shown and described in detail, it is to be understood that the subject matter which is encompassed by the present invention is limited only by the claims.

What is claimed is:

1. System comprising:
TV display;
TV processor controlling the display and accessing a tangible computer readable storage medium bearing instructions to cause the processor to:
receive a demonstration video containing a video stream and metadata embedded in the stream;
present the video stream; and
overlay on the video stream an on-screen display (OSD) containing text and/or symbols represented by the metadata at screen locations indicated by the metadata.

2. The system of claim 1, wherein the demonstration video with metadata is provided on an optical disk engageable with a disk player communicating with the TV processor.

3. The system of claim 1, wherein the TV processor is programmed to recognize the metadata, wherein TV processors lacking programming to recognize the metadata can play the video stream but cannot present the OSD overlaid thereon.

4. The system of claim 1, wherein the symbol includes a box and/or circle.

5. The system of claim 1, wherein the text indicates an absence of a display anomaly.

6. The system of claim 5, wherein the anomaly is a moiré pattern and/or mosquito noise.

7. The system of claim 1, wherein the metadata defines a script executed by the TV processor to establish the OSD at a screen location and at a video temporal location defined by the script.

8. The system of claim 2, wherein the disk bears plural scripts established by plural sets of metadata each associated with a respective refresh rate, the TV processor selecting the script corresponding to the refresh rate and/or native screen resolution of the TV.

9. A computer readable storage medium storing:
at least one demonstration video; and
metadata embedded in the video and defining a script executable by a TV processor to overlay on the video an on-screen display (OSD) having text and/or symbols highlighting the benefit of at least one predetermined TV feature as exemplified in the video.

10. The medium of claim 9, wherein the metadata includes code corresponding to processor commands.

11. The medium of claim 10, wherein the metadata includes code corresponding to desired text.

12. The medium of claim 10, wherein the metadata includes code corresponding to desired OSD symbols.

13. The medium of claim 9, wherein the medium stores metadata establishing plural scripts, each associated with a respective TV model type.

14. The medium of claim 13, wherein each script is associated with a respective frame refresh rate and/or native screen resolution.

15. A method comprising:
displaying a TV in a retail outlet;
engaging a demonstration video disk with a video disk player communicating with the TV;
presenting on the TV a demonstration video on the disk;
accessing a metadata script on the disk; and
responsive to commands in the script, overlaying, on the demonstration video presented on the TV, an on-screen display (OSD) containing symbols and/or text called out in metadata on the disk.

16. The method of claim 15, wherein the metadata requires presentation of both a symbol identifying a video location and text associated with the symbol and explaining a predetermined video feature for the video location.

17. The method of claim 16, wherein the text indicates an absence of a video anomaly.

18. The method of claim 15, wherein the symbol and/or text are overlaid on portions of the video identified in the metadata script, at video stream temporal locations identified in the metadata script.

19. The method of claim 15, comprising permitting a user to enter a value set to the TV that selects a specific set of metadata to interpret for that TV.

20. The method of claim 15, wherein the metadata includes graphic images that are presented as transparent overlays.
